(19) United States
(12) Patent Application Publication
(10) Pub. No.: US 2026/0124825 A1
(43) Pub. Date: May 7, 2026

(54) THERMALLY BONDED ARTICLES

(71) Applicant: Dow Global Technologies LLC, Midland, MI (US)

(72) Inventors: Albert Carbonell Blanch, Tarragona (ES); Georgia Natacha Eftalie Bitinis, Tarragona (ES); Joseph L. Deavenport, Lake Jackson, TX (US)

(21) Appl. No.: 18/936,012

(22) Filed: Nov. 4, 2024

(51) Int. Cl. B32B 27/12; B32B 27/08; B32B 27/32

(52) U.S. Cl. CPC B32B 27/12; B32B 27/08; B32B 27/32; B32B 2250/04; B32B 2250/242; B32B 2262/0253; B32B 2307/72; B32B 2307/7376; B32B 2323/043; B32B 2323/046

(57) ABSTRACT

Embodiments of the present disclosure are directed towards thermally bonded articles including a polyethylene filament material and a multilayer backing material, where the polyethylene filament material is thermally bonded to the multilayer backing material.

### FIELD OF DISCLOSURE

Embodiments of the present disclosure are directed towards thermally bonded articles including a polyethylene filament material and a multilayer backing material, where the polyethylene filament material is thermally bonded to the multilayer backing material.

### BACKGROUND

Artificial turf is a synthetic surface that can mimic the appearance and feel of natural grass, commonly used in sports fields, residential lawns, and commercial landscapes. It is made by tufting synthetic fibers into a backing material, which is then coated with an adhesive for stability. The fibers are cut to a specific height to create a uniform, grass-like pile. Artificial turf is valued for its low maintenance requirements, durability, and ability to withstand heavy use in various climates. However, there remains a need for articles that can provide one or more advantageous properties.

### SUMMARY

The present disclosure provides various embodiments, including, without limitation, the following.

A thermally bonded article including: a polyethylene filament material and a multilayer backing material that is thermally bonded to the polyethylene filament material, wherein the multilayer backing material includes a first reduced-density polyethylene layer, a high-density polyethylene layer, and a second reduced-density polyethylene layer.

### DETAILED DESCRIPTION

The present disclosure is directed toward thermally bonded articles including a polyethylene filament material and a multilayer backing material that is thermally bonded to the polyethylene filament material, wherein the multilayer backing material includes a first reduced-density polyethylene layer, a high-density polyethylene layer, and a second reduced-density polyethylene layer. As used and discussed further herein, a “reduced-density polyethylene” has a lower density as compared to a “high-density polyethylene”, i.e., HPDE. As used and discussed further herein, a “reduced-density polyethylene” has a density less than 0.940 g/cm³, in contrast to a “high-density polyethylene”, which has a density equal to or greater than 0.945 g/cm³.

Advantageously, the thermally bonded articles disclosed herein are made from polyethylene. The thermally bonded articles disclosed herein may be referred as mono-material articles as they are made from one material, i.e. polyethylene. Mono-material articles are advantageously more recyclable as compared to multi-material articles, i.e. articles made from more than one polypropylene.

Mono-material articles, such as the thermally bonded articles disclosed herein, are desirable for a number of applications, such as artificial turf, where recyclability after an intended lifetime may be preferrable. Polypropylene, which has previously been utilized for primary backing leading to a multi-material turf system in combination with polyethylene filament, can have a relatively higher melting point as compared to polyethylene. This relatively higher melting point is also undesirable for thermal bonding.

Advantageously, the thermally bonded articles disclosed herein can provide an improved, i.e. greater, seal strength as compared other articles that have a similar filament material and similar core material, e.g., in the backing material. This improved seal strength is desirable for a number of applications, such as artificial turf, where the improved seal strength may improve the useability properties, e.g. tuft lock, and/or extend the intended lifetime of the artificial turf.

As mentioned, the thermally bonded articles disclosed herein include a polyethylene filament material.

As used herein, “polyethylene” incudes various polyethylene polymers, such as high-density polyethylene (HDPE), linear low-density polyethylene (LLDPE), ultra low-density polyethylene (ULDPE), medium-density polyethylene (MDPE), and low-density polyethylene (LDPE), among others. The term “polymer” refers to a polymeric compound prepared by polymerizing monomers, whether of a same or a different type. The generic term polymer thus embraces the term “homopolymer,” which refers to a polymer prepared from only one type of monomer as well as “copolymer,” which refers to a polymer prepared from two or more different monomers.

“Polyethylene” e.g., polyethylene polymers, refer to polymers comprising greater than 50% by mole of units derived from ethylene monomer.

Embodiments provide that from 55 to 100 wt % of the polyethylene is derived from ethylene monomers, based on a total weight of the polyethylene. All individual values and subranges from 55 to 100 wt % are included; for example, the polyethylene can have from a lower limit of 55, 60, 70, or 75 wt % of units derived ethylene monomers to an upper limit of 100, 99.9, 97, 95, 90, 85, or 80 wt % of units derived ethylene monomers based upon the total weight of the polyethylene.

One or more embodiments provide that from 0.1 to 45 wt % of polyethylene is derived from comonomers, when a comonomer is utilized, based on a total weight of the polyethylene. One or more embodiments provide that the comonomer is an alpha olefin comonomer. All individual values and subranges from 0.1 to 45 wt % are included; for example, the polyethylene can have from a lower limit of 0.1, 3, 5, 10, 15, or 20 wt % of units derived from comonomer to an upper limit of 45, 40, 30, or 25 wt % of units derived from comonomer based upon the total weight of the polyethylene.

Embodiments provide that the polyethylene filament material includes a reduced-density polyethylene. As mentioned, the reduced-density polyethylene has a lower density as compared to HDPE. One or more embodiments provide that the polyethylene filament material includes LLDPE, MDPE, or combinations thereof, which are a reduced-density polyethylenes. Various types of reduced-density polyethylene, e.g., various types of LLDPE and/or MDPE, may be utilized for different applications.

Embodiments of the present disclosure provide that reduced-density polyethylene can be made by a number of processes, e.g. with conventional reaction components, reaction conditions, reaction times, and isolation procedures, utilized for making known reduced-density polyethylene, such as LLDPEs for instance, among other reduced-density polyethylenes. Embodiments of the present disclosure provide that the reduced-density polyethylene can be obtained commercially. Examples of commercially available reduced-density polyethylene include those under the tradename DOWLEX, such as DOWLEX 2606GC, DOWLEX GM8490, and DOWLEX SC2108G, those under the tradename AFFINITY, such as AFFINITY 1880G, from The Dow Chemical Company, among other commercially available reduced-density polyethylenes.

One or more embodiments provide that a blend of polyethylene, e.g., a blend of reduced-density polyethylenes, may be utilized. Various reduced-density polyethylenes and differing amounts of reduced-density polyethylenes can be used for different applications. “Blend of polyethylenes” refers to a composition of two or more polyethylenes; “blend of polyethylenes” does not refer to laminates. Such blends of polyethylenes can be prepared as dry blends, formed in situ, e.g., in a reactor, melt blends, or using other techniques known to those of skill in the art.

Embodiments provide that the reduced-density polyethylene can have density less than 0.940 g/cm³. For instance, the reduced-density polyethylene can have density from 0.885 g/cm³ to 0.939 g/cm³. All individual values and subranges from 0.885 g/cm³ to 0.939 g/cm³ are included; for example, the reduced-density polyethylene can have a density from a lower limit of 0.885, 0.890, 0.0900, or 0.910 g/cm³ to an upper limit of 0.939, 0.939, or 0.937 g/cm³. Density can be determined according to ASTM D 792. As mentioned, the reduced-density polyethylene has a lower density as compared to HDPE.

Embodiments provide that the reduced-density polyethylene can have a melt index (I₂) from 0.5 to 10 dg/min. All individual values and subranges from 0.5 to 10 dg/min are included; for example, the reduced-density polyethylene can have an I₂ from a lower limit of 0.50, 0.75, or 0.90 dg/min to an upper limit of 10, 8, 6, or 5 dg/min. I₂ can be determined according to ASTM D1238.

Embodiments provide that the reduced-density polyethylene can have melt temperature from 95 to 126° C. All individual values and subranges from 95 to 126° C. are included; for example, the reduced-density polyethylene can have a melt temperature from a lower limit of 95, 96, 97, or 98° C. to an upper limit of 126, or 125.5° C. Melt temperature can be determined via Differential Scanning calorimetry according to ASTM D 3418-15. Differential scanning calorimetry (DSC) is a known technique that can be used to examine the melting of polymers. General principles of DSC measurements and applications of DSC are described in standard texts, e.g., E. A. Turi, ed., Thermal Characterization of Polymeric Materials, Academic Press, 1981.

One or more embodiments provide that the polyethylene filament material can be from 1,500 decitex (dtex) to 2,500 dtex.

One or more embodiments provide that the polyethylene filament material can be prepared utilizing known equipment, conditions, and components, and such. The polyethylene filament material can be prepared differently for various applications. For instance, one or more embodiments provide that the polyethylene filament material can be prepared utilizing a yarn filament spinning line, e.g. for use in artificial turf applications. One or more embodiments provide that the polyethylene filament material can be prepared as a tape. For instance, the polyethylene filament material can be prepared as a cast film, which is cut in small tapes and fibrillated afterward.

As mentioned, the thermally bonded articles disclosed herein include a multilayer backing material. Embodiments provide that the multilayer backing material includes at least three layers. The multilayer backing material can include: a first outer layer, e.g. an A layer; an inner layer (which may be referred to as a core layer), e.g., a B layer; and a second outer layer, e.g., a C layer. One or more embodiments provide that the A layer and the C layer are made from a same material, e.g., a same reduced-density polyethylene, such as LLPDE. One or more embodiments provide that the A layer and the C layer are made from different materials, e.g., a first reduced-density polyethylene and a second reduced-density polyethylene different than the first reduced-density polyethylene. While three layers are discussed regarding the multilayer backing material, embodiments are not so limited. For instance, one or more embodiments provide that the multilayer backing material incudes four or more layers.

Embodiments provide that the inner layer can be formed between the first outer layer and the second outer layer. In other words, the inner can be formed adjacent to the first outer layer and the second outer layer, while the inner layer separates the first outer layer and second outer layer.

One or more embodiments provides that the first outer layer of the multilayer backing material includes reduced-density polyethylene, e.g., LLDPE, as discussed herein. Various types of reduced-density polyethylene may be utilized for different applications. One or more embodiments provide that a blend of polyethylene, e.g., a blend of reduced-density polyethylenes, may be utilized for the first outer layer of the multilayer backing material.

One or more embodiments provides that the second outer layer of the multilayer backing material includes reduced-density polyethylene, e.g., LLDPE, as discussed herein. Various types of reduced-density polyethylene may be utilized for different applications. One or more embodiments provide that a blend of polyethylene, e.g., a blend of reduced-density polyethylenes, may be utilized for the second outer layer of the multilayer backing material.

One or more embodiments provides that the inner layer of the multilayer backing material includes HDPE.

As used herein, “high-density polyethylene”, i.e. HDPE, refers to polyethylenes having a density greater than or equal to 0.945 g/cm³. HDPE can be prepared with Ziegler-Natta catalysts, chrome catalysts or single-site catalysts including, but not limited to, substituted mono- or bis-cyclopentadienyl catalysts (typically referred to as metallocene), constrained geometry catalysts, phosphinimine catalysts & polyvalent aryloxyether catalysts (typically referred to as bisphenyl phenoxy).

The HDPE can have a density from 0.945 g/cm³ to 0.980 g/cm³. All individual values and subranges from 0.945 g/cm³ to 0.980 g/cm³ are included; for example, the HDPE can have a density from a lower limit of 0.945, 0.947, or 0.950 g/cm³ to an upper limit of 0.980, 0.975, or 0.970 g/cm³. Density can be determined according to ASTM D 792. Embodiments provide that the HDPE has a greater density as compared to the reduced-density polyethylene.

The HDPE can have a melt index (I₂) less than or equal to 4.0 dg/min. For instance, the HDPE can have an I₂ from 0.2 to 4 dg/min. All individual values and subranges from 0.2 to 4.0 dg/min are included; for example, the HDPE can have an I₂ from a lower limit of 0.2, 0.5, 0.75. or 1.0 dg/min to an upper limit of 4, 3, or 2.5 dg/min. I₂ can be determined according to ASTM D1238.

Embodiments provide that the HDPE can have melt temperature from 128 to 140° C. All individual values and subranges from 128 to 140° C. are included; for example, the HDPE can have a melt temperature from a lower limit of 128, 128.5, or 129° C. to an upper limit of 140, 138, or 135° C. Melt temperature can be determined via Differential Scanning calorimetry according to ASTM D 3418-15.

The HDPE can have various molecular weight distributions (MWD). One or more embodiments provide that the HDPE has a unimodal weight distribution curve. One or more embodiments provide that the HDPE has a bimodal weight distribution curve.

Embodiments of the present disclosure provide that the HDPE can be made by a number of processes, e.g. with conventional reaction components, reaction conditions, reaction times, and isolation procedures, utilized for making known HDPEs. Embodiments of the present disclosure provide that the HDPE can be obtained commercially. Examples of commercially available HDPE include those under the tradenames ELITE, DOWLEX, and CONTINUUM, from The Dow Chemical Company, among other HDPEs.

The multilayer backing material can be prepared by a known film formation process including extrusion procedures, such as cast film or blown film extrusion, or combinations thereof. The multilayer backing material can be a coextruded multilayer film, e.g., an A/B/C layered article.

The multilayer backing material can be stretched, e.g., oriented. The multilayer backing material can be stretched uniaxially. One or more embodiments provide that the multilayer backing material is stretched in the machine direction (MD). One or more embodiments provide that the multilayer backing material is stretched in a uniaxially oriented form.

One or more embodiments provide that the multilayer backing material may be machine direction oriented stretched at a stretch ratio of 1:2, 1:3, 1:4, 1:5, 1:6, 1:7, 1:7.5, or 1:8. The multilayer backing material may be stretched to provide machine direction orientation.

The multilayer backing material, i.e. a combination of the first outer layer, the inner layer, and the second outer layer, can have a thickness, e.g. a stretched thickness, from 20 to 150 micrometers (μm). All individual values and subranges from 20 μm to 150 μm are included; for example, the multilayer backing material can have a thickness from a lower limit of 20, 25, 30, or 35 μm to an upper limit of 150, 130, 125, 115, 100, or 90 μm.

One or more embodiments provide that the first outer layer (A layer) can be from 5% to 20% of a total thickness (100%) of a combination of the first outer layer, the inner layer, and the second outer layer. All individual values and subranges from 5% to 20% are included; for example, the first outer layer can be from a lower limit of 5, 7, or 8% to an upper limit of 20, 15, 13, or 12% of the total thickness (100%) of the combination of the first outer layer, the inner layer, and the second outer layer.

One or more embodiments provide that the inner layer (B layer) can be from 60% to 90% of a total thickness (100%) of a combination of the first outer layer, the inner layer, and the second outer layer. All individual values and subranges from 60% to 90% are included; for example, the inner layer can be from a lower limit of 60, 70, 74, or 76% to an upper limit of 90, 86, or 84% of the total thickness (100%) of the combination of the first outer layer, the inner layer, and the second outer layer.

One or more embodiments provide that the second outer layer (C layer) can be from 5% to 20% of a total thickness (100%) of a combination of the first outer layer, the inner layer, and the second outer layer. All individual values and subranges from 5% to 20% are included; for example, the second outer layer can be from a lower limit of 5, 7, or 8% to an upper limit of 20, 15, 13, or 12% of the total thickness (100%) of the combination of the first outer layer, the inner layer, and the second outer layer.

The multilayer backing material, either with or without one or more additional known processing steps such as, annealing, cutting, fibrillating, etc., can be utilized as a tape, a fiber, and/or a monofilament. As used herein, the terms “tape”, “fiber”, and “monofilament” include a monofilament, a multifilament, a film, a fiber, a yarn, such as, for example, tape yarn, fibrillated tape yarn, or slit-film yarn, a continuous ribbon, and/or other stretched fibrous materials.

As mentioned, embodiments of the present disclosure provide are directed towards thermally bonded articles including the polyethylene filament material and the multilayer backing material, where the polyethylene filament material is thermally bonded to the multilayer backing material. As used herein, “thermally bonded” refers to applying heat and pressure such that at least a portion of one of two or more materials, which are in contact with one another, melts and forms a heat seal (or weld) to attach to each other. Various temperatures and pressures may be utilized for different applications.

The thermal bonding can be provided by various processes and components. The thermal bonding can be achieved utilizing known equipment, conditions, and components, and such.

As mentioned advantageously, the thermally bonded articles disclosed herein can provide an improved, i.e. greater, seal strength, as compared other articles that have a similar filament material and similar core material, e.g., a same HDPE material. This improved seal strength is desirable for a number of applications, such as artificial turf, where the improved seal strength may improve the useability properties, such as tuft lock, and/or extend the intended lifetime of the artificial turf.

The multilayer backing material can be utilized to make a woven article. As used herein, a woven article, refers to an article made by interlacing two or more tapes, fibers, or monofilaments, as discussed herein, crossing each other. For instance, the multilayer backing material can be utilized to make warp yarns and welp yarns for making the woven article. Woven articles are known.

The multilayer backing material can be utilized to make a knitted article. As used herein, a knitted article, can refers to the interlocking of loops from one or more tape, fiber, or monofilaments, as discussed herein. Knitted articles are known.

These woven articles and/or knitted articles can be used to form sheeting, drapes, disposable clothing, protective clothing, outdoor fabrics, industrial fabrics, netting, bagging, rope, cordage and other products. One or more embodiments provide that these woven articles and/or knitted articles are a primary backing.

As mentioned, one or more embodiments provide that the multilayer backing material can be utilized as a primary backing. The primary backing can be an open weave of slit films, tapes or filaments, as discussed herein.

One or embodiments provide that a thermally bonded article, as discussed herein, can be made by tufting, e.g., inserting the polyethylene filament material into the multilayer backing material, and then thermally bonding, as discussed herein, the polyethylene filament material to the multilayer backing material. Various tufting methods can be utilized for different applications.

Tufting can be provided by a number of processes, e.g. with known components and known conditions. Tufting includes inserting the polyethylene filament material into the multilayer backing material to make a surface with a pile, which can either be a loop or cut pile.

As an example, the polyethylene filament material can be fed to a tufting machine where it is threaded through a series of needles. Then, the needles can penetrate the multilayer backing material to insert loops of the polyethylene filament material through it. Then, as the needles pull back, a loop of the polyethylene filament material is made on the surface of the multilayer backing material. If a loop pile is desired, the loops are left intact. If a cut pile is desired, a blade positioned close to the multilayer backing material cuts the loop, creating individual strands of yarn that stand up from the multilayer backing material. Various different stitch patterns and tufting densities can be utilized for various applications.

For some other artificial turfs, after tufting, the backing material with the tufted yarn is often coated with an adhesive, such as a latex or a polyurethane, to lock the yarn in place. Additionally, a secondary backing layer is generally added to further reinforce these other artificial turfs.

Advantageously, the present thermally bonded articles do not utilize an adhesive, such as a latex or a polyurethane, to lock the yarn in place due to the seal strength, as discussed herein. Not utilizing the adhesive can help provide that the thermally bonded articles disclosed herein are mono-material articles as they are made from one material, i.e. polyethylene. As mentioned, mono-material articles are advantageously more recyclable as compared to multi-material articles, i.e. articles made from more than one material.

Advantageously, the present thermally bonded articles do not utilize a secondary backing due to the seal strength, as discussed herein. Not utilizing the secondary backing can help provide that the thermally bonded articles disclosed herein are mono-material articles as they are made from one material, i.e. polyethylene. Further, not utilizing the secondary backing can help reduce production material costs and/or production steps, as compared to artificial turfs that utilize a secondary backing.

Additionally, the present thermally bonded articles can be made utilizing relatively lower temperatures, e.g., as compared to articles containing polypropylene. Utilizing relatively lower temperature can help maintain the integrity of the high-density core layer, for instance.

### EXAMPLES

In the Examples, various terms and designations for materials are used including, for instance, the following:

HDPE-1 (density 0.967 g/cm³; melt index I₂ 1.2 dg/min; melting temperature 134° C.; obtained from the Dow Chemical Company).

HDPE-2 (density 0.950 g/cm³; melt index I₂ 1.5 dg/min; melting temperature 129.7° C.; obtained from the Dow Chemical Company).

HDPE-3 (density 0.955 g/cm³; melt index I₂ 1.5 dg/min; melting temperature 130° C.; produced by Unipol II technology; obtained from the Dow Chemical Company).

Reduced-Density Polyethylene-1 (RDPE-1) (LLDPE; density 0.920 g/cm³; melt index I₂ 4.0 dg/min; melting temperature 116° C.; DOWLEX 2606GC obtained from the Dow Chemical Company).

RDPE-2 (LLDPE; density 0.918 g/cm³; melt index I₂ 3.5 dg/min; melting temperature 112.2° C.; DOWLEX GM8490 obtained from the Dow Chemical Company).

RDPE-3 (MDPE; density 0.935 g/cm³; melt index I₂ 2.7 dg/min; melting temperature 125.4° C.; DOWLEX SC2108G obtained from the Dow Chemical Company).

RDPE-4 (UPDPE; density 0.902 g/cm³; melt index I₂ 1.0 dg/min; melting temperature 99° C.; AFFINITY 1880G obtained from the Dow Chemical Company).

Filament material 1 (RDPE; density 0.935 g/cm³; melt index I₂ 2.7 dg/min; DOWLEX SC2108G obtained from the Dow Chemical Company).

Filament material 2 (RDPE; density 0.918 g/cm³; melt index I₂ 3.5 dg/min; DOWLEX GM8490 obtained from the Dow Chemical Company).

Filament material 3 (biocomponent filament have 50/50 ratio with RDPE-2 as sheath and RDPE-3 as core: RDPE-2; density 0.918 g/cm³; melt index I₂ 3.5 dg/min; DOWLEX GM8490 and RDPE-3; density 0.935 g/cm³; melt index I₂ 2.7 dg/min; DOWLEX SC2108G).

Multilayer backing materials 1-8 were made utilizing a 5-Layer Collin Extrusion Cast line operating a 3-layer configuration (A/B/C). The utilized conditions were: 235° C. die temperature; 8 kg/hr output; 0.8 mm die gap; 10 mm air gap; 200 mm width; 3.5 m/min take off speed; 55° C. chill roll temperature; 200 μm tape thickness, where the A layer was 10% (20 μm), the B layer was 80% (160 μm), and the C layer was 10% (20 μm) of the total thickness (200 μm).

Each of multilayer backing materials 1-8 was respectively stretched utilizing a Collin Tape line with a stretching ratio of 7.5 at 130° C. (set temperature). No fibrillation was made prior stretching.

The components and final thicknesses are reported in Table 1.

TABLE 1

| | | | | Stretched |
|---|---|---|---|---|
| | A | B | C | Thickness |
| | layer | layer | layer | (μm) |
| Multilayer | RDPE-2 | HDPE-1 | RDPE-2 | 38 |
| backing | | | | |
| material | | | | |
| 1 | | | | |
| Multilayer | RDPE-1 | HDPE-1 | RDPE-1 | 44 |
| backing | | | | |
| material | | | | |
| 2 | | | | |
| Multilayer | RDPE-4 | HDPE-1 | RDPE -4 | 38 |
| backing | | | | |
| material | | | | |
| 3 | | | | |
| Multilayer | RDPE-2 | HDPE-3 | RDPE-2 | 86 |
| backing | | | | |
| material | | | | |
| 4 | | | | |
| Multilayer | RDPE-3 | HDPE-1 | RDPE -3 | 37 |
| backing | | | | |
| material | | | | |
| 5 | | | | |
| Multilayer | HDPE-2 | HDPE-2 | HDPE-2 | 76 |
| backing | | | | |
| material | | | | |
| 6 | | | | |
| Multilayer | HDPE-1 | HDPE-1 | HDPE-1 | 46 |
| backing | | | | |
| material | | | | |
| 7 | | | | |
| Multilayer | HDPE-3 | HDPE-3 | HDPE-3 | 85 |
| backing | | | | |
| material | | | | |
| 8 | | | | |

A number of properties were determined for Multilayer backing materials 1-8. The results are reported below.

TABLE 2

| | Stress at | Strain at | | |
|---|---|---|---|---|
| | break | Break | Stress at 5% | Shrinkage MD |
| | (MPa) | (%) | (MPa) | (%) |
| Multilayer | 188 | 14.4 | 120 | 0.67 |
| backing | | | | |
| material | | | | |
| 1 | | | | |
| Multilayer | 198 | 16.0 | 111 | 0.56 |
| backing | | | | |
| material | | | | |
| 2 | | | | |
| Multilayer | 201 | 14.5 | 124 | 0.56 |
| backing | | | | |
| material | | | | |
| 3 | | | | |
| Multilayer | 223 | 13.0 | 150 | 0.44 |
| backing | | | | |
| material | | | | |
| 5 | | | | |
| Multilayer | 194 | 18.3 | 113 | 0.83 |
| backing | | | | |
| material | | | | |
| 6 | | | | |
| Multilayer | 218 | 19.0 | 120 | 0.44 |
| backing | | | | |
| material | | | | |
| 7 | | | | |
| Multilayer | 181 | 27.6 | 97 | 1.39 |
| backing | | | | |
| material | | | | |
| 8 | | | | |

The data of Table 2 show that utilizing RDPE in layer A and C can provide improved, i.e. higher, or comparable mechanical properties and improved, i.e. lower, or comparable MD shrinkage values compared to multilayer backing material 6, 7 and 8.

Filament materials 1-3 were processed utilizing a Collin fiber spinning line with the following conditions.

TABLE 3

| | Filament | | Filament | | Filament | |
|---|---|---|---|---|---|---|
| | material 1 | | material 2 | | material 3 | |
| | Inner | Outer | Inner | Outer | Inner | Outer |
| | Extruder | Extruder | Extruder | Extruder | Extruder | Extruder |
| Feeding | 35 | 35 | 35 | 35 | 35 | 35 |
| Zone (° C.) | | | | | | |
| Zone 1 (° C.) | 180 | 180 | 180 | 180 | 180 | 180 |
| Zone 2 (° C.) | 205 | 205 | 205 | 205 | 205 | 205 |
| Zone 3 (° C.) | 210 | 210 | 210 | 210 | 210 | 210 |
| Capillary | 220 | 220 | 220 | 220 | 220 | 220 |
| block (° C.) | | | | | | |
| Adapter (° C.) | 230 | 230 | 230 | 230 | 230 | 230 |
| Die (° C.) | 230 | 230 | 230 | 230 | 230 | 230 |
| Pump (rpm) | 28.5 | 28.5 | 28.5 | 28.5 | 28.5 | 28.5 |

| | | | |
|---|---|---|---|
| Roll 1 (° C.) | 112 | 97 | 97 |
| Roll 2 (° C.) | 125 | 112 | 112 |
| Roll 3 (° C.) | 125 | 112 | 112 |
| Roll 4 (° C.) | 125 | 112 | 112 |
| Roll 1 | 61 | 47 | 47 |
| Speed (m/min) | | | |
| Roll 4 | 250 | 235 | 235 |
| Speed (m/min) | | | |

Example 1-1, a thermally bonded article, was made by thermally bonding Multilayer backing material 1 and Filament material 3 as follows. The thermal bonding included placing a respective filament material between 2 instances of a respective multilayer backing material. The thermal bonding was performed at 120° C. and 130° C. using sealing bars (0.7 s and 0.5 MPa, using flat surface geometry, sealing bar dimension 200*10 mm).

Example 1-2 was made as Example 1-1, with the change that a thermal bonding temperature of 130° C. was utilized rather than 120° C.

Example 2-1 was made as Example 1-1, with the change that Multilayer backing material 2 was utilized rather than Multilayer backing material 1.

Example 2-2 was made as Example 2-1, with the change that a thermal bonding temperature of 130° C. was utilized rather than 120° C.

Comparative Example A-1 was made as Example 1-1 with the change that Multilayer backing material 7 was utilized rather than Multilayer backing material 1.

Comparative Example A-2 was made as Comparative Example A-1 with the change that a thermal bonding temperature of 130° C. was utilized rather than 120° C.

TABLE 4

| | Thermal bonding | |
|---|---|---|
| | temperature | Seal strength |
| | (° C.) | (N) |
| Example 1-1 | 120 | 22.2 |
| (Multilayer backing | | |
| material 1/Filament | | |
| material 3) | | |
| Example 2-1 | 120 | 21.3 |
| (Multilayer backing | | |
| material 2/Filament | | |
| material 3) | | |
| Comparative Example A-1 | 120 | 12.8 |
| (Multilayer backing | | |
| material 7/Filament | | |
| material 3) | | |
| Example 1-2 | 130 | 17.0 |
| (Multilayer backing | | |
| material 1/Filament | | |
| material 3) | | |
| Example 2-2 | 130 | 18.4 |
| (Multilayer backing | | |
| material 2/Filament | | |
| material 3) | | |
| Comparative Example A-2 | 130 | 9.2 |
| (Multilayer backing | | |
| material 7/Filament | | |
| material 3) | | |

The data of Table 4 show that each of Example 1-1 and Example 2-1 had an improved, i.e. greater, seal strength as compared to Comparative Example A-1.

The data of Table 4 show that each of Example 1-2 and Example 2-2 had an improved, i.e. greater, seal strength as compared to Comparative Example A-2.

Example 3-1 was made as Example 1-1, with the change that Filament material 1 was utilized rather than Filament material 3.

Example 3-2 was made as Example 3-1, with the change that a thermal bonding temperature of 130° C. was utilized rather than 120° C.

Example 4-1 was made as Example 3-1, with the change that Multilayer backing material 2 was utilized rather than Multilayer backing material 1.

Example 4-2 was made as Example 4-1, with the change that a thermal bonding temperature of 130° C. was utilized rather than 120° C.

Example 5-1 was made as Example 3-1, with the change that Multilayer backing material 4 was utilized rather than Multilayer backing material 1.

Example 5-2 was made as Example 5-1, with the change that a thermal bonding temperature of 130° C. was utilized rather than 120° C.

Example 6-1 was made as Example 3-1, with the change that Multilayer backing material 5 was utilized rather than Multilayer backing material 1.

Example 6-2 was made as Example 6-1, with the change that a thermal bonding temperature of 130° C. was utilized rather than 120° C.

Comparative Example B-1 was made as Example 3-1 with the change that Multilayer backing material 7 was utilized rather than Multilayer backing material 1.

Comparative Example B-2 was made as Comparative Example B-1, with the change that a thermal bonding temperature of 130° C. was utilized rather than 120° C.

Comparative Example C-1 was made as Example 3-1 with the change that Multilayer backing material 8 was utilized rather than Multilayer backing material 1.

Comparative Example C-2 was made as Comparative Example C-1, with the change that a thermal bonding temperature of 130° C. was utilized rather than 120° C.

TABLE 5

| | Thermal bonding | |
|---|---|---|
| | temperature | Seal strength |
| | (° C.) | (N) |
| Example 3-1 | 120 | 27.9 |
| (Multilayer backing | | |
| material 1/Filament | | |
| material 1) | | |
| Example 4-1 | 120 | 24.2 |
| (Multilayer backing | | |
| material 2/Filament | | |
| material 1) | | |
| Example 5-1 | 120 | 19.2 |
| (Multilayer backing | | |
| material 4/Filament | | |
| material 1) | | |
| Example 6-1 | 120 | 11.0 |
| (Multilayer backing | | |
| material 5/Filament | | |
| material 1) | | |
| Comparative Example B-1 | 120 | — |
| (Multilayer backing | | |
| material 7/Filament | | |
| material 1) | | |
| Comparative Example C-1 | 120 | 0.0 |
| (Multilayer backing | | |
| material 8/Filament | | |
| material 1) | | |
| Example 3-2 | 130 | 26.8 |
| (Multilayer backing | | |
| material 1/Filament | | |
| material 1) | | |
| Example 4-2 | 130 | 29.2 |
| (Multilayer backing | | |
| material 2/Filament | | |
| material 1) | | |
| Example 5-2 | 130 | 25.7 |
| (Multilayer backing | | |
| material 4/Filament | | |
| material 1) | | |
| Example 6-2 | 130 | 22.3 |
| (Multilayer backing | | |
| material 5/Filament | | |
| material 1) | | |
| Comparative Example B-2 | 130 | 10.8 |
| (Multilayer backing | | |
| material 7/Filament | | |
| material 1) | | |
| Comparative Example C-2 | 130 | 8.1 |
| (Multilayer backing | | |
| material 8/Filament | | |
| material 1) | | |

The data of Table 5 show that each of Example 3-1, Example 4-1, Example 5-1, and Example 6-1 had an improved, i.e. greater, seal strength as compared to Comparative Example C-1.

The data of Table 5 show that each of Example 3-2, Example 4-2, Example 5-2, and Example 6-2 had an improved, i.e. greater, seal strength as compared to both Comparative Example B-2 and Comparative Example C-2.

Example 7-1 was made as Example 1-1, with the change that Filament material 2 was utilized rather than Filament material 3.

Example 7-2 was made as Example 7-1, with the change that a thermal bonding temperature of 130° C. was utilized rather than 120° C.

Example 8-1 was made as Example 7-1, with the change that Multilayer backing material 2 was utilized rather than Multilayer backing material 1.

Example 8-2 was made as Example 8-1, with the change that a thermal bonding temperature of 130° C. was utilized rather than 120° C.

Comparative Example D-1 was made as Example 7-1 with the change that Multilayer backing material 7 was utilized rather than Multilayer backing material 1.

Comparative Example D-2 was made as Comparative Example D-1, with the change that a thermal bonding temperature of 130° C. was utilized rather than 120° C.

TABLE 6

| | Thermal bonding | |
|---|---|---|
| | temperature | Seal strength |
| | (° C.) | (N) |
| Example 7-1 | 120 | 14.4 |
| (Multilayer backing | | |
| material 1/Filament | | |
| material 2) | | |
| Example 8-1 | 120 | 16.5 |
| (Multilayer backing | | |
| material 2/Filament | | |
| material 2) | | |
| Comparative Example D-1 | 120 | 5.1 |
| (Multilayer backing | | |
| material 7/Filament | | |
| material 2) | | |
| Example 7-1 | 130 | 8.6 |
| (Multilayer backing | | |
| material 1/Filament | | |
| material 2) | | |
| Example 8-1 | 130 | 9.7 |
| (Multilayer backing | | |
| material 2/Filament | | |
| material 2) | | |
| Comparative Example D-1 | 130 | 3.3 |
| (Multilayer backing | | |
| material 7/Filament | | |
| material 2) | | |

The data of Table 6 show that each of Example 7-1 and Example 8-1 had an improved, i.e. greater, seal strength as compared to Comparative Example D-1.

The data of Table 6 show that each of Example 7-2 and Example 8-2 had an improved, i.e. greater, seal strength as compared to Comparative Example D-2.

Tensile tests (Stress at break (MPa), Strain at Break (%), Stress at 5% (MPa)) were performed on a 200×15 mm sample, clamp distance of 100 mm, and tensile speed is 500 mm/min, according to ISO 527.

Shrinkage % was measured in an oven on sample of 360×50 mm width, at 90° C. for 20 s, according to ISO 11501. Shrinkage was measured in MD direction (360 mm).

The seal strength was measured 48 hours after the seal was performed. The seal was performed at 120 and 130° C. using sealing bars (0.7 s and 0.5 MPa). The seal strength was measured by clamping the filament material in the upper jaw and the multilayer backing materials on the bottom one. The distance between the clamps was 25.5 mm and the tensile speed was 100 mm/min.

Density was determined according to ASTM D 792, A1 Procedure C, Test within 1 hr, measured on compression molded plate prepared following ATSM D4703.

Melt index (I₂) was determined according to ASTM D1238, measured at 190° C. and with a 2.16 kg weight.

Melt temperature was determined via Differential Scanning calorimetry according to ASTM D 3418-15, using a heating rate of 10° C./min.

What is claimed is:

1. A thermally bonded article comprising:
a polyethylene filament material; and
a multilayer backing material that is thermally bonded to the polyethylene filament material, wherein the multilayer backing material includes a first reduced-density polyethylene layer, a high-density polyethylene layer, and a second reduced-density polyethylene layer.

2. The thermally bonded article of claim 1, wherein the polyethylene filament material comprises a reduced-density polyethylene.

3. The thermally bonded article of claim 1, wherein the high-density polyethylene layer is formed adjacent to the first reduced-density polyethylene layer and the second reduced-density polyethylene layer, while the inner layer separates the first reduced-density polyethylene layer and the second reduced-density polyethylene layer.

4. The thermally bonded article of claim 1, wherein the first reduced-density polyethylene layer and the second reduced-density polyethylene layer include a same reduced-density polyethylene.

5. The thermally bonded article of claim 4, wherein the same reduced-density polyethylene has density less than 0.940 g/cm³.

6. The thermally bonded article of claim 1, wherein the polyethylene filament material, the first reduced-density polyethylene layer, and the second reduced-density polyethylene layer include a same linear low-density polyethylene.

7. The thermally bonded article of claim 1, wherein the polyethylene filament material includes a first linear low-density polyethylene and the first reduced-density polyethylene layer and the second reduced-density polyethylene layer include a second linear low-density polyethylene, wherein the first linear low-density polyethylene is different than the second linear low-density polyethylene.

8. The thermally bonded article of claim 1, wherein the multilayer backing material has a thickness from 20 to 150 micrometers.

9. The thermally bonded article of claim 1, wherein:
the first reduced-density polyethylene layer is from 5% to 20% of a total thickness of a combination of the first reduced-density polyethylene layer, the high-density polyethylene layer, and the second reduced-density polyethylene layer;
the second reduced-density polyethylene layer is from 5% to 20% of the total thickness of the combination of the first reduced-density polyethylene layer, the high-density polyethylene layer, and the second reduced-density polyethylene layer; and
the high-density polyethylene layer is from 60% to 90% of the total thickness of the combination of the first reduced-density polyethylene layer, the high-density polyethylene layer, and the second reduced-density polyethylene layer.

10. The thermally bonded article of claim 1, wherein the high-density polyethylene layer includes a high-density polyethylene having a density greater than or equal to 0.945 g/cm³.
